(19) United States
(12) Patent Application Publication
(10) Pub. No.: US 2022/0113793 A1
(43) Pub. Date: Apr. 14, 2022

(54) METHOD FOR GENERATING REPLY MESSAGE, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Jingming WANG, Beijing (CN); Xiang GE, Beijing (CN); Xiantao CHEN, Beijing (CN); Meng XU, Beijing (CN)

(21) Appl. No.: 17/556,564

(22) Filed: Dec. 20, 2021

(30) Foreign Application Priority Data
Feb. 26, 2021 (CN) 202110219962.6

(51) Int. Cl. G06F 3/01; G06F 1/16

(52) U.S. Cl. CPC G06F 3/011; G06F 1/163; G06F 3/017

(57) ABSTRACT

The present disclosure provides a method for generating a reply message. The method includes: acquiring a current application scene of a user; acquiring a target object type in conversation with the user; generating at least one candidate reply content corresponding to the application scene and matching with the target object type in an expression style; and adjusting the expression style of the candidate reply content according to an expression style of the user on historical content, to generate at least one target reply content.

### CROSS-REFERENCE TO RELATED APPLICATION

The disclosure claims priority to Chinese Patent Application No. 202110219962.6, filed on Feb. 26, 2021, the content of which is hereby incorporated by reference into this disclosure.

### TECHNICAL FIELD

The present disclosure relates to a field of computer technologies, specifically to a field of input method technologies, and particularly to a method for generating a reply message, an electronic device and a storage medium.

### BACKGROUND

A smart watch, as an auxiliary wearable device of a smart phone, provides message receiving, reminding and replying functions, which meets instant messaging requirements of the user when inconvenient to use the mobile phone.

### SUMMARY

The present disclosure provides a method for generating a reply message, an electronic device and a storage medium.

According to embodiments of the present disclosure, a method for generating a reply message is provided. The method includes: acquiring a current application scene of a user; acquiring a target object type in conversation with the user; generating at least one candidate reply content corresponding to the application scene and matching with the target object type in an expression style; and adjusting the expression style of the candidate reply content according to an expression style of the user on historical content, to generate at least one target reply content.

According to embodiments of the present disclosure, an electronic device is provided. The electronic device includes: at least one processor; and a memory communicatively coupled to the at least one processor; in which, the memory is stored with instructions executable by the at least one processor, in which the instructions are executed by the at least one processor, so that the at least one processor can execute the method for generating a reply message according to the first aspect.

According to embodiments of the present disclosure, a non-transitory computer-readable storage medium stored with computer instructions is provided, in which the computer instructions are configured to cause a processor to execute a method for generating a reply message according to the first aspect.

It should be understood that, the content described in this part is not intended to recognize key or important features of embodiments of the present disclosure, nor intended to limit the scope of the present disclosure. Other features of the present disclosure will be easy to understand through the following specification.

### BRIEF DESCRIPTION OF THE DRAWINGS

The drawings are intended to better understand the solution, and do not constitute a limitation to the disclosure.

FIG. 1 is a flowchart illustrating a method for generating a reply message in embodiments of the present disclosure;

FIG. 2 is a flowchart illustrating another method for generating a reply message in embodiments of the present disclosure;

FIG. 3 is a flowchart illustrating another method for generating a reply message in embodiments of the present disclosure;

FIG. 4 is a diagram illustrating a method for generating a reply message in embodiments of the present disclosure;

FIG. 5 is a block diagram illustrating an apparatus for generating a reply message in embodiments of the present disclosure;

FIG. 6 is a block diagram illustrating another apparatus for generating a reply message in embodiments of the present disclosure;

FIG. 7 is a block diagram illustrating another apparatus for generating a reply message in embodiments of the present disclosure;

FIG. 8 is a block diagram illustrating another apparatus for generating a reply message in embodiments of the present disclosure;

FIG. 9 is a block diagram illustrating an electronic device of a method for generating a reply message in embodiments of the present disclosure.

### DETAILED DESCRIPTION

The exemplary embodiments of the present disclosure are described as below with reference to the accompanying drawings, which include various details of embodiments of the present disclosure to facilitate understanding, and should be considered as merely exemplary. Therefore, those skilled in the art should realize that various changes and modifications may be made to the embodiments described herein without departing from the scope and spirit of the present disclosure. Similarly, for clarity and conciseness, descriptions of well-known functions and structures are omitted in the following descriptions.

A smart watch, as an auxiliary wearable device of a smart phone, provides message receiving, reminding and replying functions, which meets instant messaging requirements of the user when inconvenient to use the mobile phone. However, due to a limited screen size of the smart watch, traditional keyboard or handwriting input is low in input efficiency on the smart watch, and voice input is limited in scene applicability though not limited by the screen size, for example, when an error occurs in some short replies, the modification cost is higher.

In practical applications, a user rarely actively initiates a message through the smart watch, and mainly rapidly replies to a message when not convenient to use the mobile phone, to confirm or postpone a specific conversation. In such an application scene, a fast reply actually most meets the user's requirements, and has the highest input efficiency. However, in practical applications, the user is not prone to use a default fast reply due to its sense of distance.

The below refers to a method and an apparatus for generating a reply message, an electronic device and a storage medium in embodiments of the present disclosure.

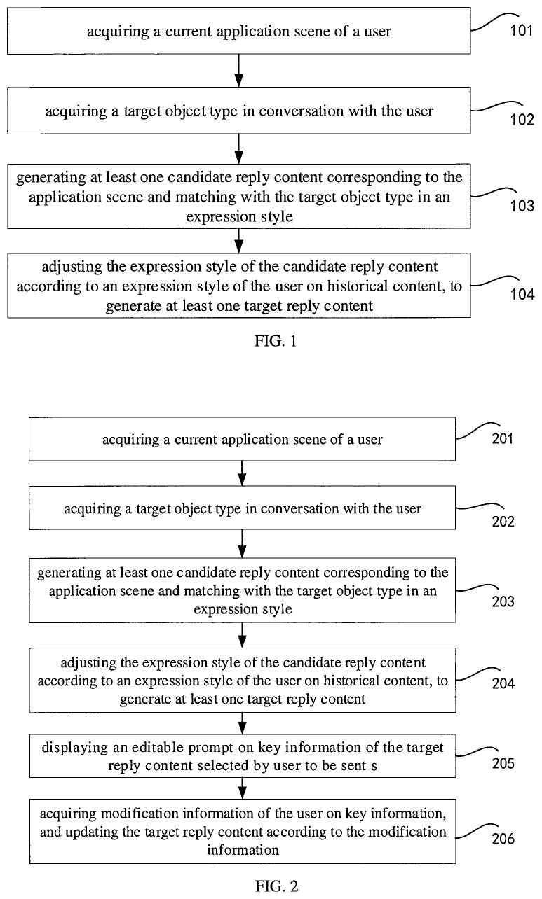

FIG. 1 is a flowchart illustrating a method for generating a reply message in embodiments of the present disclosure. It should be noted that, the method for generating a reply message in embodiments of the present disclosure may be applied to an apparatus for generating a reply message in embodiments of the present disclosure. The apparatus for generating a reply message may be configured on an electronic device. The electronic device may be understood as a smart device, for example, the smart device may be a smart phone, a smart watch, a personal digital assistant, etc. with various operating systems. As an example, the smart device may be a smart phone.

As illustrated in FIG. 1, the method for generating a reply message includes the following blocks.

At block 101, a current application scene of a user is acquired.

In at least one embodiment, the current application scene of the user is acquired through detection parameters collected by a sensor on the smart device, and/or the current application scene of the user may be acquired through log information and/or application information on the smart device. That is, the current application scene of the user is determined mainly based on the following several input sources: detection parameters collected by the sensor on the smart device, and/or log information configured by the user on the smart device, and/or applications currently running on the smart device, etc. Therefore, in some embodiments, the current application scene of the user may be acquired by one or more following ways.

Way One

A current activity state of the user is acquired through parameter information detected by the sensor on the smart device.

In embodiments, the sensor may include but is not limited to one or more of an acceleration sensor, a heart rate sensor, a global positioning system (GPS), etc. As an example, the sensor may include an acceleration sensor, a heart rate sensor, and a GPS, in which, the acceleration sensor may be configured to detect movement of the user, the heart rate sensor may be configured to detect the user's heart rate, and the GPS may locate the user and the user's movement trajectory. In this way, the current application scene of the user may be determined by the acceleration sensor, the heart rate sensor, and the GPS.

As one example, the application scene may be divided into a relatively static state, a moving state, and a motion state, etc. When the application scene is a relatively static state, the heart rate is within a quiet heart rate range, and the GPS and the acceleration sensor show that the user is relatively static, and at this time, the user may be in a relatively static activity such as at office, at a meeting, in class, watching TV, etc. When the application scene is a moving state, the GPS shows that the user is moving, and whether the user is walking, riding or in other movement modes may be determined according to the moving speed, the heart rate and the acceleration sensor. When the application scene is a motion state, whether the user is in the motion state may be determined according to the heart rate, and whether it is the outdoor motion or the indoor motion may be further determined in combination with the heart rate variation rule and the GPS.

As another example, the current application scene of a user may be acquired through an ambient noise level measured by a microphone on the smart device. For example, the ambient noise level may be measured by the microphone on the smart device, and the current application scene of the user is determined by the noise level, further to determine whether it is suitable for voice input.

Way Two

The current application scene of the user is acquired through log information configured on the smart device by the user.

In at least one embodiment, the user may configure log or schedule information through the application on the smart device, so that the current application scene of the user may be determined by acquiring the log information configured by the user on the smart device. For example, the smart device is a smart watch, and the smart watch has supported a schedule connection with a mobile phone and makes a reminder before the start of the schedule. In embodiments, it may be determined whether the current application scene of the user is possibly in a meeting, motion or other busy state through the log information or schedule information configured by the user.

Way Three

The current application scene of the user is acquired through the application currently running on the smart device.

In at least one embodiment, since the application currently running on the smart device may reflect the current application scene of the user to a certain degree, the current application scene of the user may be determined by acquiring the application currently running on the smart device. For example, the smart device is a smart watch, and the application running on the smart watch may also be used to assist in determining the current application scene of the user. For example, when the user is in a motion state, the smart watch may start a corresponding sports application to provide a movement guidance or record; when the user is in a meeting, the smart watch may be in a do-not-disturb mode; when the user is on the road, the smart watch may be in a map voice navigation mode, etc.

It needs to be noted that, the current application scene of the user may be acquired by one or more of above ways. For example, when the current application scene of the user is acquired in the above multiple ways, the application scene acquired in various ways may be mutually verified to ultimately and accurately determine the current application scene of the user. As an example, the log information configured on the smart device in the above way two may be used to determine whether the user is possibly in a meeting, motion or other busy state, and the parameter information detected by the sensor on the smart device in the above way one may be used to verify the result, so as to determine the current application scene of the user.

At block 102, a target object type in conversation with the user is acquired.

It should be noted that, when people communicate with different objects and relationships, different sessions may be used. Therefore, when a fast reply message is generated, the type of the target object in conversation with the user may be determined first. In at least one embodiment, a group type to which the message received by the user belongs may be acquired and the target object type in conversation with the user may be determined according to the group type; and/or, a user label preset by the user for the target object may be acquired, and the target object type in conversation with the user may be determined according to the user label. The group type may be understood as a type of a communication software, and the type of the communication software may be divided into a working communication software and a private communication software.

As one example, the target object in conversation with the user may be determined based on the source of the message received by the user. In addition, the user may actively configure a label for the object in conversation with the user, such as family, friend, colleague, boss, etc. In this way, the user label preset by the user for the target object may be acquired, and the target object type in conversation with the user may be determined according to the user label.

At block 103, at least one candidate reply content corresponding to the application scene and matching with the target object type in an expression style is generated.

In at least one embodiment, the candidate reply content corresponding to the application scene and matching with the target object type in the expression style is generated according to the current application scene of the user and the target object type in conversation with the user. In some embodiments, the reply content may include: a confirmation type reply content, and/or a postponing type reply content etc.

As an example, corresponding content text information may be generated according to the current application scene of the user, and the expression style used for the content which the user replies to the target object may be determined according to the target object type in conversation with the user, so that the candidate reply content can be generated according to the content text information and the expression style. For example, when it is determined that the user needs to reply a message to his family when moving, two types of replies may be generated, in which one type of reply content is: a notification and confirmation reply, such as “I got it, I'm in the gym”; in which, another type of reply content is a postponing reply, such as “I'm doing exercise, talk to you later”.

At block 104, the expression style of the candidate reply content is adjusted according to the expression style of the user on the historical content, to generate at least one target reply content.

In embodiments of the present disclosure, the historical content may include but not limited to the historical content input on the input interface, and the input interface may be an input interface in a searching scene, or an input interface in a chatting scene.

In at least one embodiment, when the candidate reply content is obtained, the expression style of the candidate reply content may be adjusted according to the expression style of the user on the historical content to obtain the target reply content. For example, when it is determined that the user needs to reply a message to a family when moving, two types of replies may be generated, in which, one type of reply content is: a notification and confirmation reply, such as “I got it, I'm in the gym”; another type of reply content is a postponing reply, such as “I'm doing exercise, talk to you later”. At this time, by reading an input habit of the user on the smart device, and adjusting a session (that is, the candidate reply content) based on the individual communication expression style of the user, for example, including mood words, punctuation marks, emoticons, the adjusted result may be: a notification and confirmation reply, such as “I got it˜, I'm in the gym [symbol] ”; or a postponing reply, such as “I'm doing exercise, talk to you later [symbol] ”.

According to the method for generating a reply message in embodiments of the disclosure, the current application scene of the user may be acquired and the target object type in conversation with the user may be acquired to generate at least one candidate reply content corresponding to the application scene and matching with the target object type in the expression style, and the expression style of the candidate reply content is adjusted according to the expression style of the user on the historical content to generate at least one target reply content. It can be seen that, the disclosure can determine the current application scene of the user and the conversation object to generate a scenic fast reply content, and adjust the expression style of the candidate reply content according to the expression style of the user on the historical content to generate the fast reply content that meets a personalized expression style of the user, thereby greatly enhancing a scene applicability of the fast reply and optimizing user experience for the smart watch.

FIG. 2 is a flowchart illustrating another method for generating a reply message in embodiments of the present disclosure. As illustrated in FIG. 2, the method for generating a reply message includes the following blocks.

At block 201, a current application scene of a user is acquired.

In embodiments of the present disclosure, block 201 may be implemented in any one way described in embodiments of the present disclosure, which is not limited here and not repeated here.

At block 202, a target object type in conversation with the user is acquired.

In embodiments of the present disclosure, block 202 may be implemented in any one way described in embodiments of the present disclosure, which is not limited here and not repeated here.

At block 203, at least one candidate reply content corresponding to the application scene and matching with target object type in an expression style is generated.

In embodiments of the present disclosure, block 203 may be implemented in any one way described in embodiments of the present disclosure, which is not limited here and not repeated here.

At block 204, the expression style of the candidate reply content is adjusted according to the expression style of the user on the historical content to generate at least one target reply content.

In embodiments of the present disclosure, block 204 may be implemented in any one way described in embodiments of the present disclosure, which is not limited here and not repeated here.

At block 205, an editable prompt is displayed on key information of the target reply content selected by user to be sent.

In at least one embodiment, when at least one target reply content is generated, the at least one target reply content may be provided to the user, and the user may select one target reply content according to its own requirement and take the target reply content selected by the user as the target reply content to be sent. At this block, an editable prompt may be displayed on the key information of the target reply content selected by user to be sent, so that the user may know through the editable prompt that personalized editing may be performed on the key information of the target reply content to be sent.

For example, when the user selects a corresponding target reply content to be sent, the key information of the target reply content to be sent may be extracted and the editable prompt may be displayed on the key information. For example, the key information may be highlighted in an underlined form to inform the user that the underlined text content may be edited, and the user may click the corresponding position to edit the text content corresponding to the underlined position, in which the editing may include operations such as modification, deletion, etc.

At block 206, modification information of the user on key information is acquired, and the target reply content is updated according to the modification information.

In embodiments of the present disclosure, the key information may be scene-related information in the target reply content, or may also be time information or location information in the target reply content. For example, for scene-related information “I'm doing exercise”, the user may select to delete this information or amend it to another state, such as “meeting”, “on the road”, etc.; for the postponing reply information “talk to you later”, the user may also select to adjust it to a specific time interval such as “contact you after one hour”, or a particular time point “contact you at 12:00”.

According to the method for generating a reply message in embodiments of the disclosure, when at least one target reply content is generated, the at least one target reply content may be provided to the user, and the user may select the target reply content according to its own requirement and takes the target reply content selected by the user as the target reply content to be sent. In this way, the editable prompt may be displayed on the key information of the target reply content selected by user to be sent, so that the user may know through the editable prompt that the key information of the target reply content to be sent can be edited. By acquiring the modification information of the user on the key information, the target reply content is updated according to the modification information, so that the fast reply content that meets personalized requirements and the communication style of the user can be obtained, which correctly reflects a text description of the current application scene of the user, and may be vivid and sincere to people to close the sense of distance between the user and the conversation object.

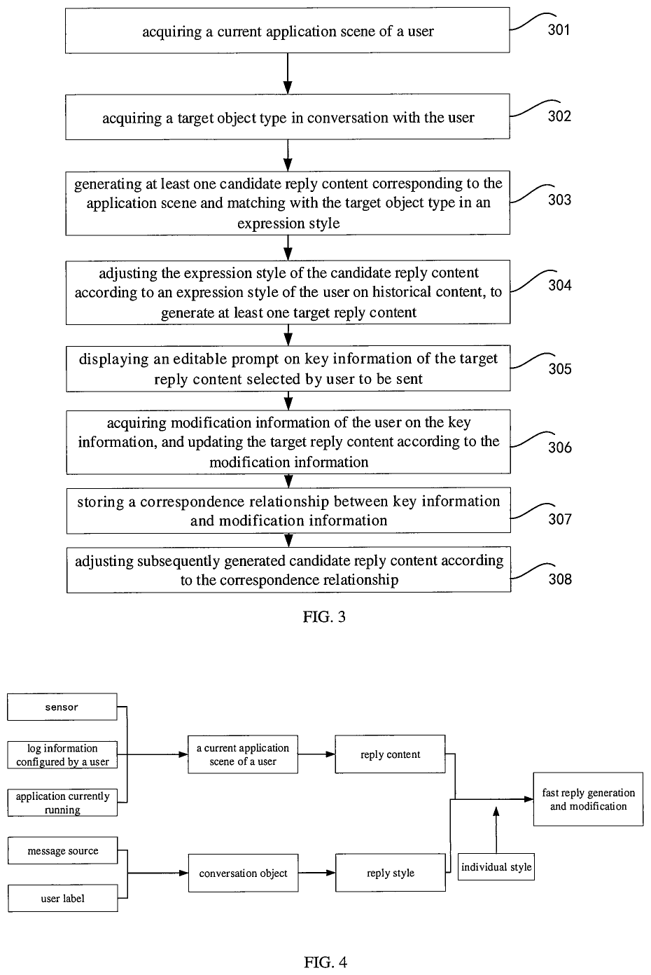

In some embodiments of the present disclosure, on the basis of FIG. 2, as illustrated in FIG. 3, after the target reply content is updated according to the modification information, the method for generating a reply message may further following blocks.

At block 307, a correspondence relationship between key information and modification information is stored.

At block 308, subsequently generated candidate reply content is adjusted according to the correspondence relationship.

In at least one embodiment, after the target reply content is updated according to the modification information of the key information, the correspondence relationship between the key information and the modification information may be stored, so that the subsequently generated candidate reply content is adjusted according to the correspondence relationship. That is, after the user modifies the key information, the correspondence relationship between the key information and the modification information may be stored, so that when the reply content is generated next time, the composition mode of the key information and the modification information actually used by or most commonly used by the user may be preferentially presented, to enable the generated target reply content to meet the personalized communication style of the user.

It needs to be noted that, the implementation of blocks 301 to 306 in FIG. 3 is the same as the implementation of blocks 201 to 206 in FIG. 2, which is not repeated here.

For example, as illustrated in FIG. 4, taking the smart device as a smart watch for an example, when the smart watch receives incoming information or messages (such as a short message, a chatting message), the user needs to give a fast reply through the smart watch, at this time, the current application scene of the user may be determined by acquiring parameter information detected by the sensor on the smart watch, log information configured by the user on the smart watch and the application currently running on the smart device, and the target object type in conversation with the user may be determined by acquiring the message source of the message received by the user and the user label of the target object in conversation with the user. Then, fast reply content may be initially generated according to the current application scene of the user and the target object type in conversation with the user. For example, when it is determined that the user needs to reply a message to a family when moving, two types of replies may be generated, in which one type of reply content is: a notification and confirmation reply, such as “I got it, I'm in the gym”; another type of reply content is a postponing reply, such as “I'm doing exercise, talk to you later”. Then, by reading the input habit of the user on the mobile phone and adjusting the session (that is, the candidate reply content) based on the individual communication expression style of the user, for example, including mood words, punctuation marks, emoticons, the adjusted result may be: \textcircled{1} notification and confirmation reply, such as “I got it˜, I'm in the gym [symbol] ”; \textcircled{2} or a postponing reply, such as “I'm doing exercise, talk to you later [symbol] ”.

For another example, after the user selects the corresponding fast reply, key information may be further rapidly modified according to the personal style, and the key information may be highlighted in an underlined form. The user clicks the corresponding position to select the key information. For example, for scene-related information “I'm doing exercise”, the user may select to delete this information or amend it to other states, such as “in a meeting”, “on the road”, etc.; for postponing reply information “talk to you later”, the user may also select to adjust to a specific time interval such as “contact you after one hour”, or a particular time point “contact you at 12:00”. Then, when the next reply content is generated, the composition mode actually used or most commonly used by the user may be preferentially presented.

In some embodiments, it may be detected whether the current scene feature meets a preset trigger condition. When the scene feature meets the trigger condition, the target reply content is sent to the target object. As an example, the trigger condition may include a specific activity or time period or object, etc. For example, for the specific activity or time period or object, the user may start an intelligent reply. In this way, when it is detected that the current scene feature meets the preset trigger condition, the target reply content may be automatically sent to the target object, thereby achieving the function of intelligent reply, further achieving the purpose of fast reply.

FIG. 5 is a block diagram illustrating an apparatus for generating a reply message in embodiments of the present disclosure. As illustrated in FIG. 5, the apparatus for generating a reply message may include a first acquiring module 501, a second acquiring module 502, a first generating module 503 and a second generating module 504.

The first acquiring module 501 is configured to acquire a current application scene of a user. As an example, the first acquiring module 501 is specifically configured to acquire a current activity state of the user through the parameter information detected by a sensor configured on a smart device; and/or, acquire the current application scene of the user through log information configured on the smart device by the user; and/or, acquire the current application scene of the user through the application currently running on the smart device. The second acquiring module 502 is configured to acquire a target object type in conversation with the user. In at least one embodiment, the second acquiring module 502 is specifically configured to acquire a group type to which a message received by the user belongs and determine the target object type in conversation with the user according to the group type; and/or, acquire a user label preset by the user for a target object, and determine the target object type in conversation with the user according to the user label.

The first generating module 503 is configured to generate at least one candidate reply content corresponding to the application scene and matching with target object type in an expression style. In some embodiments, reply content may include a confirmation type reply content, and/or a postponing type reply content.

The second generating module 504 is configured to adjust an expression style of the candidate reply content according an expression style of the user on historical content, to generate at least one target reply content.

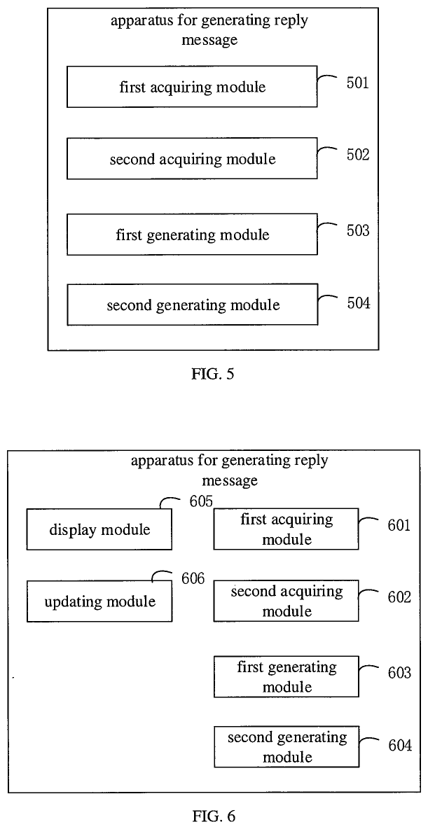

In some embodiments of the present disclosure, as illustrated in FIG. 6, on the basis of FIG. 5, the apparatus for generating a reply message may further include a display module 605 and an updating module 606. The display module 605 is configured to display an editable prompt on key information of the target reply content selected by the user to be sent. The updating module 606 is configured to acquire modification information of the user on key information, and update the target reply content according to the modification information. Modules 601 to 604 in FIG. 6 have the same function and structure with modules 501 to 504 in FIG. 5.

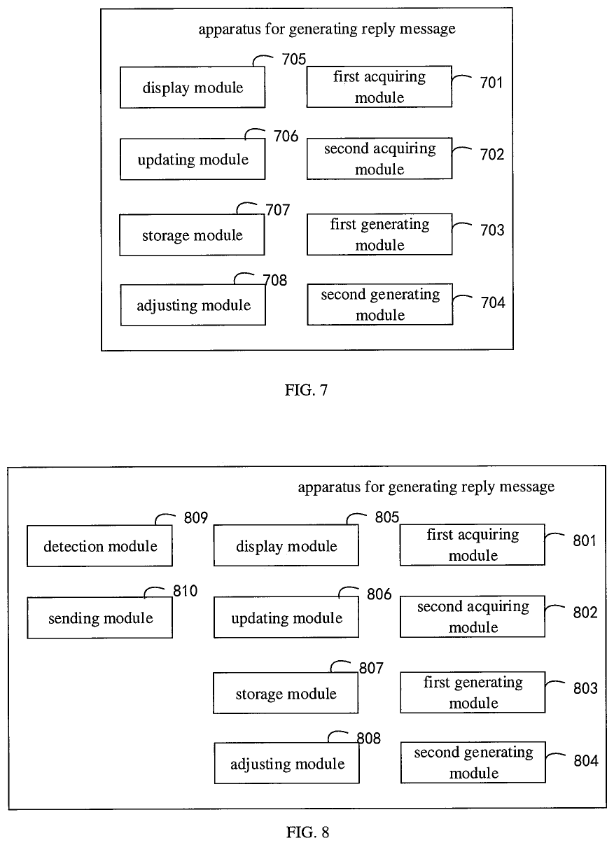

In some embodiments of the present disclosure, as illustrated in FIG. 7, on the basis of FIG. 6, the apparatus for generating a reply message may further include a storage module 707 and an adjusting module 708. The storage module 707 is configured to store a correspondence relationship between the key information and the modification information after the updating module 606 updates the target reply content according to the modification information. The adjusting module 708 is configured to adjust the subsequently generated candidate reply content according to the correspondence relationship. Modules 701 to 706 in FIG. 7 have the same function and structure with modules 601 to 606 in FIG. 6.

In some embodiments of the present disclosure, as illustrated in FIG. 8, on the basis of FIG. 7, the apparatus for generating a reply message may further include a detection module 809 and a sending module 810. The detection module 809 is configured to detect whether the current scene feature satisfies a preset trigger condition. The sending module 810 is configured to send the target reply content to the target object when the scene feature satisfies the trigger condition. Modules 801 to 808 in FIG. 8 have the same function and structure with modules 701 to 708 in FIG. 7.

With regard to the apparatus in the above embodiments, the specific way in which each module performs the operation has been described in detail in the embodiments of the method and will not be elaborated here.

According to the apparatus for generating a reply message in the embodiments of the disclosure, the current application scene of the user may be acquired and the target object type in conversation with the user may be acquired to generate at least one candidate reply content corresponding to the application scene and matching with the target object type in the expression style; and the expression style of the candidate reply content is adjusted according to the expression style of the user on the historical content to generate at least one target reply content. It can be seen that, in the disclosure, the current application scene of the user and the conversation object may be determined to generate a scenic fast reply content, and the expression style of the candidate reply content may be adjusted according to the expression style of the user on the historical content to generate the fast reply content that meets a personalized expression style of the user, thereby greatly enhancing the scene applicability of the fast reply and optimizing user experience for the smart watch.

According to embodiments of the present disclosure, an electronic device and a readable storage medium are further provided.

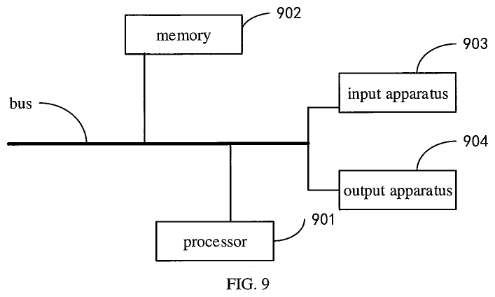

FIG. 9 is a block diagram illustrating an electronic device configured to implement a method for generating a reply message in embodiments of the present disclosure. The electronic device is intended to represent various types of digital computers, such as laptop computers, desktop computers, workstations, personal digital assistants, servers, blade servers, mainframe computers, and other suitable computers. The electronic device may also represent various types of mobile apparatuses, such as personal digital assistants, cellular phones, smart phones, wearable devices, and other similar computing devices. The components shown herein, their connections and relations, and their functions are merely examples, and are not intended to limit the implementation of the disclosure described and/or required herein.

As illustrated in FIG. 9, the electronic device includes: one or more processors 901, a memory 902, and an interface configured to connect various components, including a high-speed interface and a low-speed interface. The various components are connected to each other with different buses, and may be installed on a public main board or installed in other ways as needed. The processor may process instructions executed in the electronic device, including instructions stored in or on the memory to display graphical information of the GUI on an external input/output device (such as a display device coupled to an interface). In other implementations, a plurality of processors and/or a plurality of buses may be configured with a plurality of memories if necessary. Similarly, the processor may connect a plurality of electronic devices, and each device provides a part of necessary operations (for example, as a server array, a group of blade servers, or a multi-processor system). FIG. 9 takes one processor 901 as an example.

The memory 902 is a non-transitory computer-readable storage medium provided in the present disclosure. The memory stores instructions executable by the at least one processor, so that the at least one processor executes a method for generating a reply message as described in the present disclosure. The non-transitory computer-readable storage medium of the present disclosure stores computer instructions, in which the computer instructions are configured to execute a method for generating a reply message by a computer provided in the present disclosure.

As a non-transitory computer-readable storage medium, the memory 902 may be configured to store non-transitory software programs, non-transitory computer-executable programs and modules, such as program instructions/modules corresponding to a method for generating a reply message in the embodiment of the present disclosure (for example, a first acquiring module 501, a second acquiring module 502, a first generating module 503 and a second generating module 504 as illustrated in FIG. 5). The processor 901 executes various functional applications and data processing of the server by running a non-transitory software program, an instruction, and a module stored in the memory 902, that is, a method for generating a reply message in the above method embodiment is implemented.

The memory 902 may include a program storage area and a data storage area; the program storage area may store operation systems and application programs required by at least one function; the data storage area may store data created based on the use of an electronic device for generating a reply message, etc. In addition, the memory 902 may include a high-speed random access memory, and may also include a non-transitory memory, such as at least one magnetic disk storage device, a flash memory device, or other non-transitory solid-state storage devices. In some embodiments, the memory 902 optionally includes a memory set remotely relative to the processor 901 that may be connected to an electronic device for generating a reply message via a network. The example of the above networks includes but not limited to an Internet, an enterprise intranet, a local area network, a mobile communication network and their combination.

The electronic device configured to implement the method for generating a reply message may further include an input apparatus 903 and an output apparatus 904. The processor 901, the memory 902, the input apparatus 903, and the output apparatus 904 may be connected through the bus or in other ways. FIG. 9 takes connection through the bus as an example.

The input apparatus 903 may receive input digital or character information, and generate key signals input related to user setting and function control of an electronic device for generating a reply message, such as a touch screen, a keypad, a mouse, a track pad, a touch pad, an indicating rod, one or more mouse buttons, a trackball, a joystick and other input apparatuses. The output apparatus 904 may include a display device, an auxiliary lighting apparatus (for example, a LED) and a tactile feedback apparatus (for example, a vibration motor), etc. The display device may include but not limited to a liquid crystal display (LCD), a light emitting diode (LED) display and a plasma display. In some implementations, a display device may be a touch screen.

Various implementation modes of the systems and technologies described herein may be implemented in a digital electronic circuit system, an integrated circuit system, a dedicated ASIC (application specific integrated circuit), a computer hardware, a firmware, a software, and/or combinations thereof. The various implementation modes may include: being implemented in one or more computer programs, and the one or more computer programs may be executed and/or interpreted on a programmable system including at least one programmable processor, and the programmable processor may be a dedicated or a general-purpose programmable processor that may receive data and instructions from a storage system, at least one input apparatus, and at least one output apparatus, and transmit the data and instructions to the storage system, the at least one input apparatus, and the at least one output apparatus.

The computer programs (also called as programs, software, software applications, or codes) include machine instructions of a programmable processor, and may be implemented with high-level procedure and/or object-oriented programming languages, and/or assembly/machine languages. As used herein, the terms “a machine-readable medium” and “a computer-readable medium” refer to any computer program product, device, and/or apparatus configured to provide machine instructions and/or data for a programmable processor (for example, a magnetic disk, an optical disk, a memory, a programmable logic device (PLD)), including a machine-readable medium that receive machine instructions as machine-readable signals. The term “a machine-readable signal” refers to any signal configured to provide machine instructions and/or data for a programmable processor.

In order to provide interaction with the user, the systems and technologies described here may be implemented on a computer, and the computer has: a display apparatus for displaying information to the user (for example, a CRT (cathode ray tube) or a LCD (liquid crystal display) monitor); and a keyboard and a pointing apparatus (for example, a mouse or a trackball) through which the user may provide input to the computer. Other types of apparatuses may further be configured to provide interaction with the user; for example, the feedback provided to the user may be any form of sensory feedback (for example, visual feedback, auditory feedback, or tactile feedback); and input from the user may be received in any form (including an acoustic input, a voice input, or a tactile input).

The systems and technologies described herein may be implemented in a computing system including back-end components (for example, as a data server), or a computing system including middleware components (for example, an application server), or a computing system including front-end components (for example, a user computer with a graphical user interface or a web browser through which the user may interact with the implementation mode of the system and technology described herein), or a computing system including any combination of such back-end components, middleware components or front-end components. The system components may be connected to each other through any form or medium of digital data communication (for example, a communication network). Examples of communication networks include: a local area network (LAN), a wide area network (WAN), an internet and a blockchain network.

The computer system may include a client and a server. The client and server are generally far away from each other and generally interact with each other through a communication network. The relation between the client and the server is generated by computer programs that run on the corresponding computer and have a client-server relationship with each other. A server may be a cloud server, also known as a cloud computing server or a cloud host, is a host product in a cloud computing service system, to solve the shortcomings of large management difficulty and weak business expansibility existed in the traditional physical host and Virtual Private Server (VPS) service. A server further may be a server with a distributed system, or a server in combination with a blockchain.

According to the technical scheme in the embodiments of the disclosure, the current application scene of the user may be acquired and the target object type in conversation with the user may be acquired to generate at least one candidate reply content corresponding to the application scene and matching with the target object type in the expression style; and the expression style of the candidate reply content is adjusted according to the expression style of the user on the historical content to generate at least one target reply content. It can be seen that, in the disclosure, the current application scene of the user and the conversation object may be determined to generate a scenic fast reply content, and the expression style of the candidate reply content may be adjusted according to the expression style of the user on the historical content to generate a fast reply content that meets a personalized expression style of the user, thereby greatly enhancing the scene applicability of the fast reply and optimizing user experience for the smart watch.

It should be understood that, various forms of procedures shown above may be configured to reorder, add or delete blocks. For example, blocks described in the present disclosure may be executed in parallel, sequentially, or in a different order, as long as the desired result of the technical solution disclosed in the present disclosure may be achieved, which will not be limited herein.

The above specific implementations do not constitute a limitation on the protection scope of the present disclosure. Those skilled in the art should understand that various modifications, combinations, sub-combinations and substitutions may be made according to design requirements and other factors. Any modification, equivalent replacement, improvement, etc., made within the spirit and principle of embodiments of the present disclosure shall be included within the protection scope of embodiments of the present disclosure.

What is claimed is:

1. A method for generating a reply message, comprising:
acquiring a current application scene of a user;
acquiring a target object type in conversation with the user;
generating at least one candidate reply content corresponding to the application scene and matching with the target object type in an expression style; and
adjusting the expression style of the candidate reply content according to an expression style of the user on historical content, to generate at least one target reply content.

2. The method of claim 1, wherein acquiring a current application scene of a user, comprises at least one of:
acquiring a current activity state of the user through parameter information detected by a sensor configured on a smart device;
acquiring the current application scene of the user through log information configured on the smart device by the user;
acquiring the current application scene of the user through an application currently running on the smart device.

3. The method of claim 1, wherein, acquiring a target object type in conversation with the user, comprises at least one of:
acquiring a group type to which a message received by the user belongs, and determining the target object type in conversation with the user according to the group type;
acquiring a user label preset by the user for a target object, and determining the target object type in conversation with the user according to the user label.

4. The method of claim 1, wherein, the reply content comprises:
a confirmation type reply content, and/or a postponing type reply content.

5. The method of claim 1, further comprising:
displaying an editable prompt on key information of the target reply content selected by the user to be sent;
acquiring modification information of the user on the key information, and updating the target reply content according to the modification information.

6. The method of claim 5, wherein, after updating the target reply content according to the modification information, further comprising:
storing a correspondence relationship between the key information and the modification information; and
adjusting subsequently generated candidate reply content according to the correspondence relationship.

7. The method of claim 1, further comprising:
detecting whether a current scene feature satisfies a preset trigger condition;
sending the target reply content to the target object when the scene feature satisfies the trigger condition.

8. An electronic device, comprising:
at least one processor; and
a memory communicatively coupled to the at least one processor; wherein,
the memory is stored with instructions executable by the at least one processor, wherein the instructions are configured to, when executed by the at least one processor, cause the at least one processor to execute a method for generating a reply message, the method comprising:
acquiring a current application scene of a user;
acquiring a target object type in conversation with the user;
generating at least one candidate reply content corresponding to the application scene and matching with the target object type in an expression style; and
adjusting the expression style of the candidate reply content according to an expression style of the user on historical content, to generate at least one target reply content.

9. The electronic device of claim 8, wherein acquiring a current application scene of a user, comprises at least one of:
acquiring a current activity state of the user through parameter information detected by a sensor configured on a smart device;
acquiring the current application scene of the user through log information configured on the smart device by the user;
acquiring the current application scene of the user through an application currently running on the smart device.

10. The electronic device of claim 8, wherein, acquiring a target object type in conversation with the user, comprises at least one of:
acquiring a group type to which a message received by the user belongs, and determining the target object type in conversation with the user according to the group type;
acquiring a user label preset by the user for a target object, and determining the target object type in conversation with the user according to the user label.

11. The electronic device of claim 8, wherein, the reply content comprises:
a confirmation type reply content, and/or a postponing type reply content.

12. The electronic device of claim 8, wherein the method further comprises:
displaying an editable prompt on key information of the target reply content selected by the user to be sent;
acquiring modification information of the user on the key information, and updating the target reply content according to the modification information.

13. The electronic device of claim 12, wherein, after updating the target reply content according to the modification information, the method further comprises:
storing a correspondence relationship between the key information and the modification information; and
adjusting subsequently generated candidate reply content according to the correspondence relationship.

14. The electronic device of claim 8, wherein the method further comprises:
detecting whether a current scene feature satisfies a preset trigger condition;
sending the target reply content to the target object when the scene feature satisfies the trigger condition.

15. A non-transitory computer-readable storage medium stored with computer instructions, wherein the computer instructions are configured to cause a computer to implement a method for generating a reply message, the method comprising:
acquiring a current application scene of a user;
acquiring a target object type in conversation with the user;
generating at least one candidate reply content corresponding to the application scene and matching with the target object type in an expression style; and
adjusting the expression style of the candidate reply content according to an expression style of the user on historical content, to generate at least one target reply content.

16. The non-transitory computer-readable storage medium of claim 15, wherein acquiring a current application scene of a user, comprises at least one of:
acquiring a current activity state of the user through parameter information detected by a sensor configured on a smart device;
acquiring the current application scene of the user through log information configured on the smart device by the user;
acquiring the current application scene of the user through an application currently running on the smart device.

17. The non-transitory computer-readable storage medium of claim 15, wherein, acquiring a target object type in conversation with the user, comprises at least one of:
acquiring a group type to which a message received by the user belongs, and determining the target object type in conversation with the user according to the group type;
acquiring a user label preset by the user for a target object, and determining the target object type in conversation with the user according to the user label.

18. The non-transitory computer-readable storage medium of claim 15, wherein, the reply content comprises:
a confirmation type reply content, and/or a postponing type reply content.

19. The non-transitory computer-readable storage medium of claim 15, wherein the method further comprises:
displaying an editable prompt on key information of the target reply content selected by the user to be sent;
acquiring modification information of the user on the key information, and updating the target reply content according to the modification information.

20. The non-transitory computer-readable storage medium of claim 19, wherein, after updating the target reply content according to the modification information, the method further comprises:
storing a correspondence relationship between the key information and the modification information; and
adjusting subsequently generated candidate reply content according to the correspondence relationship.
